(19) United States
(12) Patent Application Publication
(10) Pub. No.: US 2016/0204650 A1
(43) Pub. Date: Jul. 14, 2016

(54) SOLAR POWERED CHARGING STATION

(71) Applicant: David Hornsby, Blountsville, AL (US)

(72) Inventor: David Hornsby, Blountsville, AL (US)

(21) Appl. No.: 14/592,964

(22) Filed: Jan. 9, 2015

(51) Int. Cl. H02J 7/35; A47C 7/62; A47B 97/00; A47C 11/00; H02J 7/00; A47B 83/02

(52) U.S. Cl. CPC H02J 7/355; H02J 7/0052; A47B 83/02; A47B 97/00; A47C 11/00; A47C 7/62; H02J 2007/0062

(57) ABSTRACT

A self-contained charging station is provided which utilizes a solar panel to generate electrical current. The panel is integrated onto a utilitarian structure wherein one or more outlets for charging portable devices are provided.

### FIELD OF INVENTION

The present invention relates to a charging station for a portable electronic device. More particularly, the present invention relates to a charging station for use in a remote location having no source of commercial electrical power. In even greater particularity, the present invention relates to a remote charging station including a solar panel incorporated onto a utilitarian structure such as a bench or table.

### BACKGROUND

As technology advances, and greater numbers of individuals find themselves dependent upon some sort of electronic communication device, both for work and social purposes, life on the go presents a problem with keeping those devices powered up. Rarely can a handheld device such as a smartphone or tablet make it through an entire day without needing to be recharged, however finding access to an electrical outlet available for public use can be difficult, in particular, in outdoor areas or areas where electrical power lines have not been established. Although, portable solar charging panels are commercially available, such devices are not widely known among the general public. There are many parks and recreation areas that are bereft of any charging facilities, thus, many patrons will choose to leave the park or otherwise shorten their intended stay in order to find access to a charging facility.

### SUMMARY OF THE INVENTION

Our Sun Charge Systems solar powered charging station is an environmentally friendly, self-contained power system built to provide access to electrical outlets for the purpose of charging personal electronic devices such as, but not limited to, cell phones, tablets, and laptops.

In one embodiment, the charging station is configured as a covered park bench having one or more solar panels mounted on the roof structure and USB charging outlets mounted in the bench area;

In another embodiment the charging station is configured as a pole supporting a solar panel with a charging shelf supported by the pole;

In yet another embodiment the charging station is configured as a picnic table with a solar panel supported in conjunction therewith and a charging station affixed to the table.

In accordance with another embodiment, the charging station is configured as an urban or rural bus stop with an enclosure within which the charging outlet is mounted and one or more solar panels are mounted to the roof.

### BRIEF DESCRIPTION OF THE DRAWINGS

Referring to the drawings which are appended hereto and which form a portion of this disclosure, it may be seen that:

FIG. 1 is a front perspective view of a park bench in one embodiment of the invention;

FIG. 2 is a rear perspective view of a park bench in the first embodiment of the invention;

FIG. 3 is front perspective view of a park bench in a second embodiment of the invention;

FIG. 4 is a perspective view of a picnic table in another embodiment of the invention;

FIG. 5 is a perspective view of a charging pole in another embodiment of the invention;

FIG. 6 is a perspective view of a bus stop charging station in another embodiment of the invention;

FIG. 7 is a typical circuit layout for any embodiment of the invention;

FIG. 8 is a pictorial illustration of the solar panel;

FIG. 9 is a pictorial illustration of the converter unit; and,

FIG. 10 is a pictorial view of the USB ports and 12 volt outlet.

### DETAILED DESCRIPTION

One or more of the above objects can be achieved, at least in part, by providing a stand-alone charging station that needs no auxiliary electrical connection to power the charging station. The fundamental features of each charging station are a charging pole 11, which is incorporated into each embodiment. Each charging pole 11 provides at least partial support for outlets 12 for a variety of charging options, such as USB charging ports, twelve volt car style charging ports, and alkali battery charging ports. By having a variety of ports, each embodiment can accommodate and be compatible with most electronic devices commonly in use. The charging pole 11 also provides at least partial support for a solar panel 15 which provides electrical energy to the system a charge controller which directs a 12 volt output to either the outlets 12 or a battery 17.

Referring to the drawings for a clearer understanding of the invention note that the charging pole 11 is preferably a formable steel pipe which may be configured by conventional pipe bending techniques to fit in the chosen embodiment. Charging pole 11 may alternatively be an aluminum or other formable metal pipe or may be a plastic or resin based pipe, however either the charging pole 11 or the structure it is incorporated into must be sufficiently load bearing to support at least the solar panel 15 and any devices to be charged in an outdoor environment where the embodiment will be subject to weather and potential tampering.

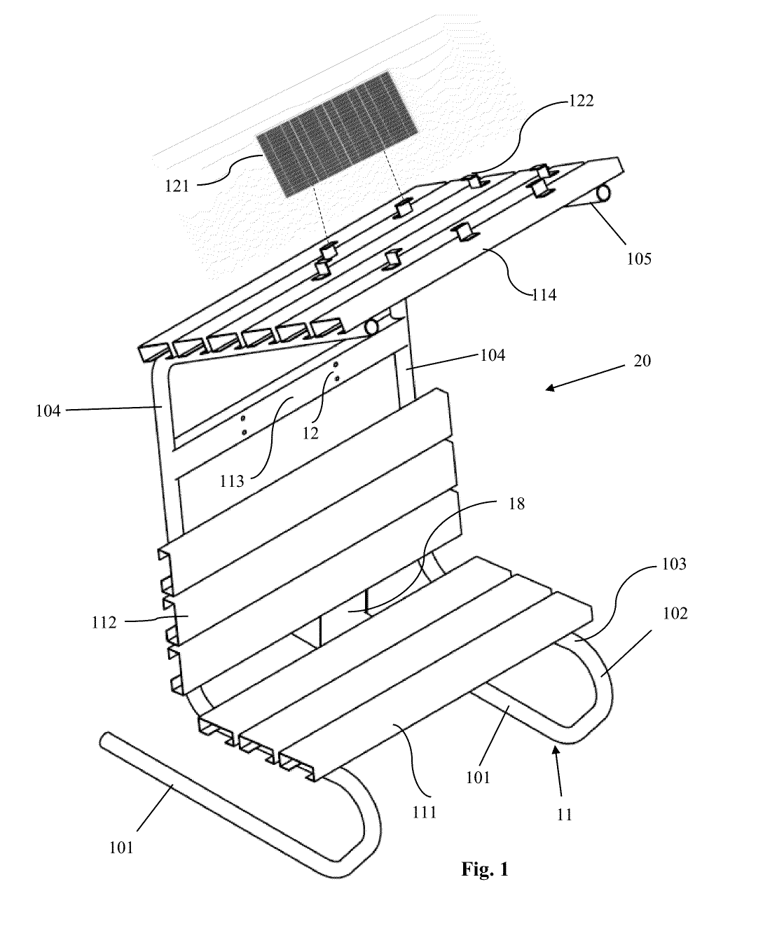

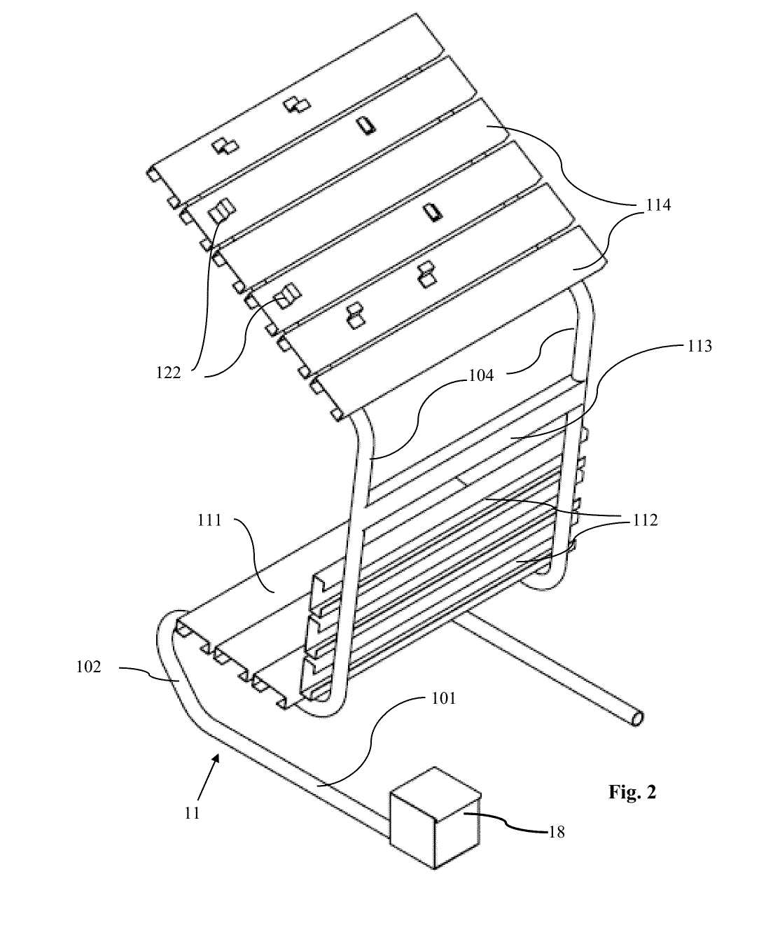

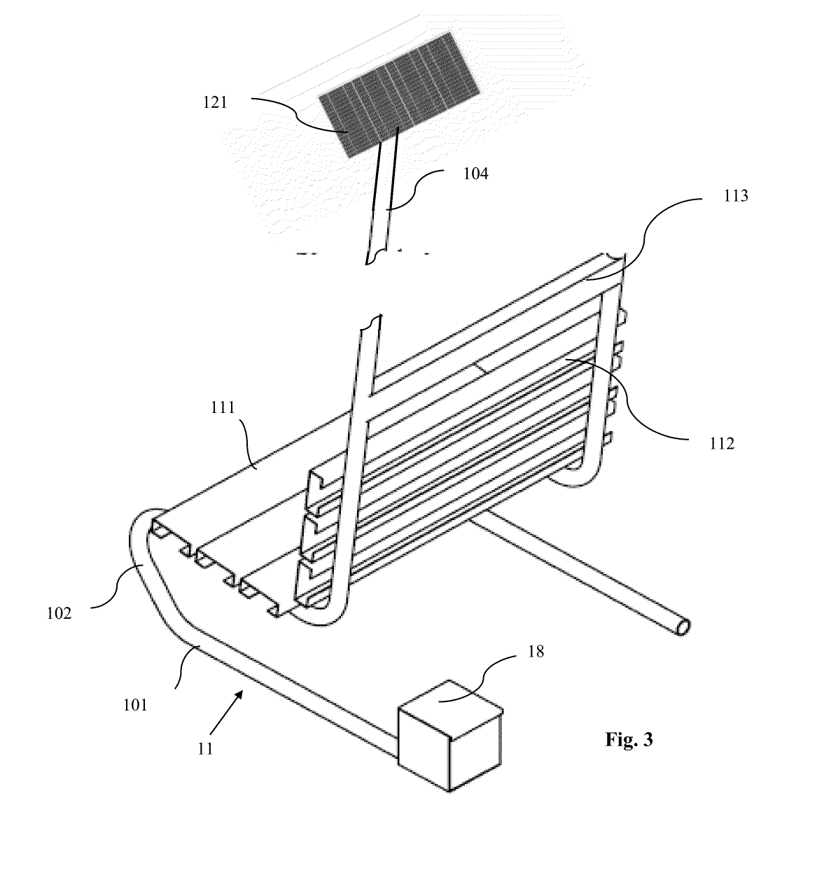

Referring to FIGS. 1 and 2, charging pole 11 is utilized as one of the support poles for a covered bench 20. In the embodiment shown, Charging pole 11 and a secondary pole 21 are tubular metal pipes formed with a lower ground engaging portion 101, an up-standing leg portion 102, a horizontal seat supporting portion 103, an upstanding back portion 104 and an angled roof supporting portion 105. Attached to the horizontal seat supporting portion 103 are one or more seat members 111 which form the basic bench seat. Attached to the upstanding back portions 104 are one or more back members 112 and a horizontal cross member 113. Attached to angled roof supporting portions 105 are one or more roof members 114. All of the attachments may be conventionally made by bolting or welding the components together. The roof members 114 are topped by a photovoltaic solar panel 121 which is connected by thereto by brackets 122. In a preferred embodiment the solar panel may be a Dasol 60 W (Model DS-A18-60) polycrystalline solar module or any commercially available module meeting the power requirements of the installation. This particular module has 72 cells, which are Laminate Glass/EVA/TPT (tedlar/pet/tedlar) or TPE, mounted in a clear anodized aluminum frame with a MC4 compatible connector and a maximum voltage a the power point of V. and a maximum amperage of 3.33 A. This unit measures 27.25″×26.25″×1.375″ and weighs 12.3 lbs.

The environmentally green solar energy is collected as a DC current output to charge controller by an insulated conductor running inside charging pole 11 to an equipment box 18 located at the base of the pole 11 or under the seat members 111. Once inside the equipment box 18, the wiring will run through a charge controller 16 to regulate the current running to and from the battery.

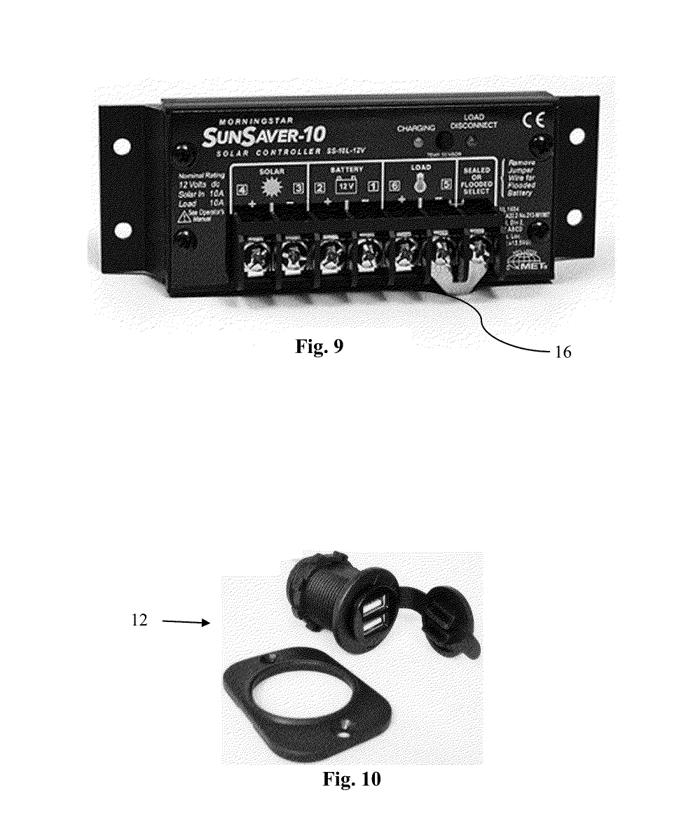

In an exemplary embodiment the charge controller 16 may be a Morningstar SunSaver SS-10L-12V Charge Controller or the equivalent. This controller provides reliability, PWM battery charging, and consistent high quality. Referring to FIG. 9, Controller 16 includes input connections 161 and 162 from the solar panel 15 from which it is provided with an input 12V Solar Current and is fully encapsulated in epoxy potting with Marine rated terminals. With an output voltage of 12V and physical dimensions of 6.0″×1.3″×2.2″, the controller 16 can easily be housed within compartment 18.

The controller has outlets 163 and 164 connected to battery 17 for charging the battery and outlets 165 and 166 which can be directly connected to the charging outlets.

The charging outlets 12 may be such as the Blue Sea Systems Dual USB Charger Socket shown in FIG. 10. This outlet is a 12V DC Dual USB Charger dashmount with protective cap and is compatible with popular mobile devices. The outlet converts 12 V DC to an output voltage of 5V DC+/−5%. Likewise, the one or more of the outlets may be configured to receive and recharge alkali batters used in portable devices as well. Multiple outlets can be installed on the same charging pole, allowing for several devices to be charged at the same time. In yet another embodiment one or more of the outlets may be a 12 volt “cigarette lighter” type automotive outlet for use by those who do not have a USB terminal connector.

As will be understood, the battery will be maintained in a charged state such that the charger may be used day or night. In some embodiments it may be desirable to include a low voltage light source on the utilitarian structure, which can be powered from the charged batteries. The light source may be operated on a timer or a light meter in conjunction with a timer such that the light source is only drawing on the battery for a predetermined time.

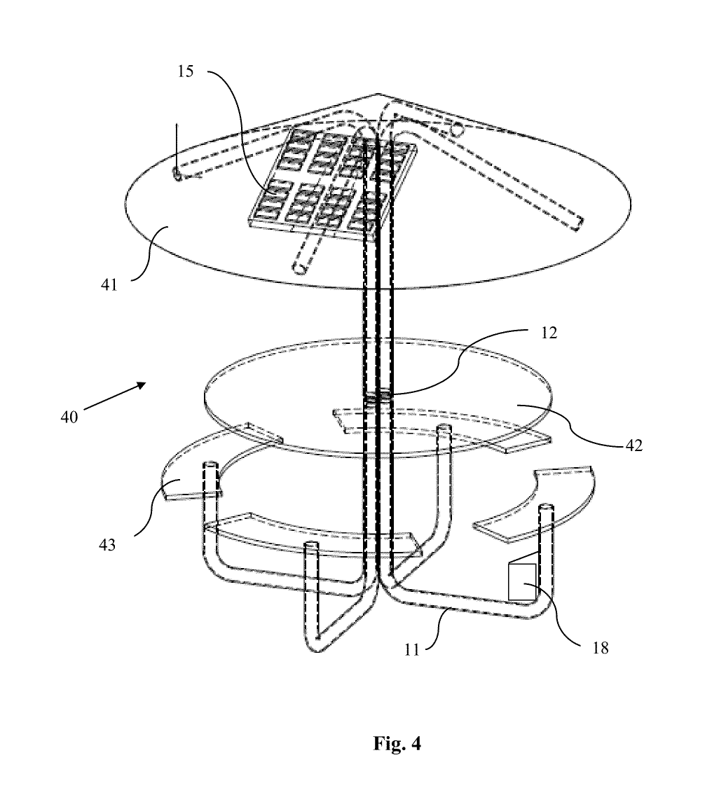

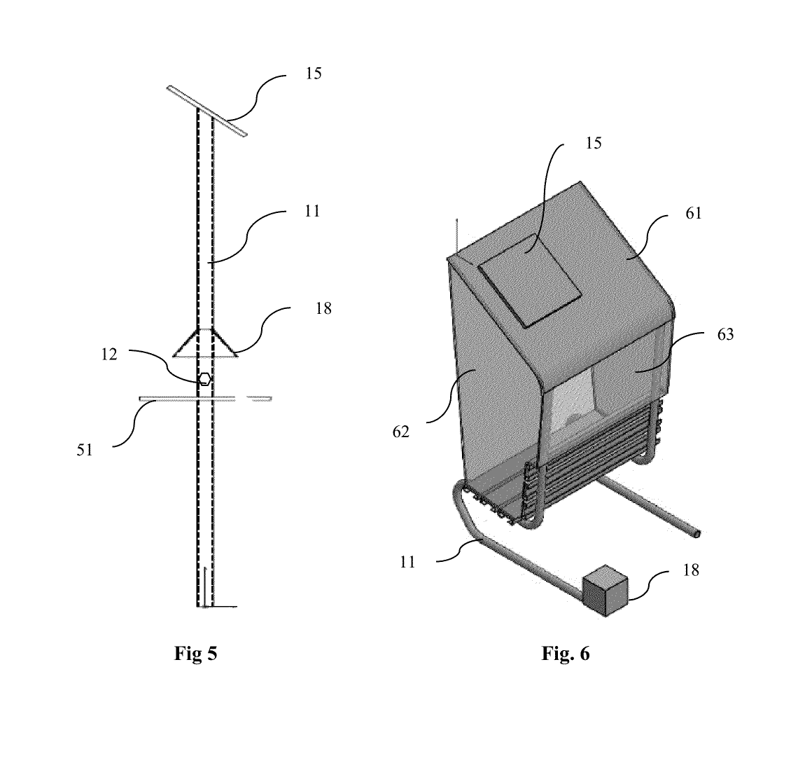

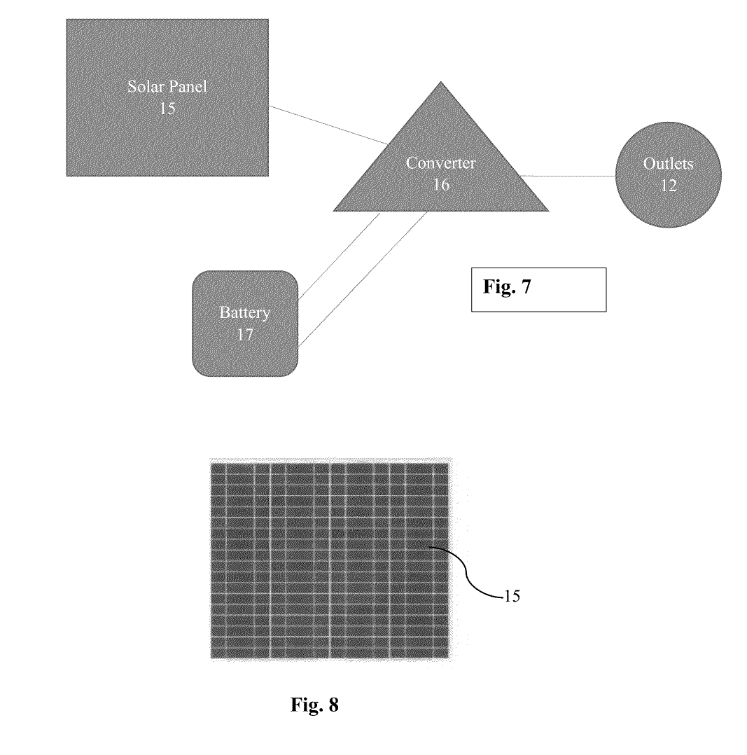

Alternative models of the Sun Charge Systems solar powered charging station will be constructed using aluminum piping, instead of steel, allowing for a lighter model. Additionally, all models of the System can be customized in attractive colors, using powder coat paints. The charging poles can be used as a free standing charging tower as shown in FIG. 5, strategically placed throughout areas such as a university campus or downtown area. Alternatively, poles can be bent into various shapes in order to be incorporated into practical and aesthetic designs, such as the picnic table 40 as shown in FIG. 4 and bus stop stations as shown in FIG. 6, to provide a complete, self-contained, green energy charging system, without taking up any additional space.

Referring to FIG. 4 The picnic table 40 charging station design may have the photovoltaic solar panel 15 on an upper canopy 41 with a table surface 42 built around the charging pole 11 or the canopy may be eliminated and the charging pole integrated into one leg of the table. The charging pole 11 would cooperate with the other legs of the table to support one or more benches 43 held in cooperative relation to the table surface 42. Like the park bench design, the table design optimally locates the equipment box 18 beneath the bench, out of the way of users. Charging outlets 12 are located above the table surface 42 on charging pole 11. Photovoltaic solar panels of various sizes can be used on any of the available designs, to accommodate greater demand in particular areas. Larger photovoltaic solar panels can convert greater amounts of solar energy, and therefore allow for greater or longer charging capabilities by the charging station. For example, a bus stop station such as shown in FIG. 6, may see greater usage and may require greater battery storage capacity for charging more devices, thus additional battery charging capacity may be needed. In the embodiment depicted as a bus stop, much of the structure of the park bench is retained, however top 61, side panels 62 and back panel 63 are added to provide some protection from the elements.

Referring to FIG. 5 it may be seen that the charging pole 11 can be provided with a shelf 51 and equipment box 18 such that the charging pole 11 is essentially a stand-alone utilitarian structure. In this embodiment it may be particularly advantageous to include a low power locator light such that the charging station can be located and used overnight as may be needed in campgrounds or other remote areas.

It may also be appreciated that the solar panels are effective if mounted with a southerly exposure and set at an angle of 18 to 25 degrees so as to sufficiently capture the light from the sun. Additionally, there are low power solar tracking devices which can be incorporated into the design to alter the inclination of the photovoltaic panel 15 depending on where the sun is in the sky.

Our Sun Charge Systems solar powered charging stations can be positioned in areas where electrical access does not adequately meet the demand of modern life. Placing these stations in city parks, campgrounds, on public beaches, outside businesses or restaurants, around university campuses, near little league parks, outside sports stadiums, or in any other outdoor public areas, will allow for convenient and efficient use of electrical charging of personal devices, without having to be tied to a wall indoors.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A self-contained charging station for portable electronic devices comprising:
a. A photo voltaic device for converting light into electrical current;
b. A tubular charging pole at least partially supporting said photo voltaic device;
c. A charge controller operably connected to said photovoltaic device via an electrical cable routed at least partially within said tubular charging pole;
d. At least one charging outlet adapted for connection to charge a portable electronic device;
e. Wherein said tubular charging pole is part of a utilitarian structure substantially permanently secured without connection to any other electrical service.

2. A self-contained charging station as defined in claim 1 wherein said utilitarian structure comprises a park bench having a seat and a back with said charging pole extending upwardly from said bench to support said photovoltaic device above said bench.

3. A self-contained charging structure as defined in claim 2 further comprising at least one roof member at least partially supported by said charging pole and supporting said photovoltaic device thereon.

4. A self-contained charging structure as defined in claim 3 wherein said photovoltaic device is a panel and is mounted an and angle of between about 18 and 25 degrees from horizontal.

5. A self-contained charging structure as defined in claim 1 wherein said utilitarian structure is a table having a table top in part supported by said charging pole and at least one bench supported by said charging pole, said charging pole extending upwardly from said table to support said photovoltaic device above said table.

6. A self-contained charging structure as defined in claim 5 further comprising at least one canopy member at least partially supported by said charging pole and supporting said photovoltaic device thereon.

7. A self-contained charging structure as defined in claim 1 wherein said utilitarian structure is a shelf supported on said charging pole to support a chargable portable electronic device while charging.
